(19) United States
(12) Patent Application Publication
(10) Pub. No.: US 2021/0261836 A1
(43) Pub. Date: Aug. 26, 2021

(54) TEMPORARY BONDING OF SUBSTRATES WITH LARGE ROUGHNESS USING MULTILAYERS OF POLYELECTROLYTES

(71) Applicant: CORNING INCORPORATED, CORNING, NY (US)

(72) Inventors: Indrani Bhattacharyya, Ithaca, NY (US); Jen-Chieh Lin, Horseheads, NY (US); Prantik Mazumder, Ithaca, NY (US)

(21) Appl. No.: 17/232,746

(22) Filed: Apr. 16, 2021

Related U.S. Application Data
(63) Continuation of application No. PCT/US2021/018087, filed on Feb. 15, 2021.
(60) Provisional application No. 62/981,659, filed on Feb. 26, 2020.

(51) Int. Cl. C09J 165/00; B32B 17/10; B32B 7/06; C03C 17/32; C09D 165/00

(52) U.S. Cl. CPC C09J 165/00; B32B 17/10036; C09D 165/00; B32B 7/06; C03C 17/32; B32B 17/1055

(57) ABSTRACT

Articles and methods of making articles, for example glass articles, comprising a thin sheet and a carrier, wherein the thin sheet and carrier are bonded together using a multilayered modification (coating) layer, for example an alternating cationic/anionic polymer coating layer, and associated deposition methods, the carrier, or both, to control van der Waals, hydrogen and covalent bonding between the thin sheet and the carrier. The modification layer bonds the thin sheet and carrier together with sufficient bond strength to prevent delamination of the thin sheet and the carrier during high temperature (≤400° C.) processing while also preventing formation of a permanent bond between the sheets during such processing.

### CROSS-REFERENCE TO RELATED APPLICATIONS

This application is a continuation and claims the benefit of priority to International Patent Application No. PCT/US2021/18087 filed on Feb. 15, 2021, which claims the benefit of priority under 35 U.S.C. § 119 of U.S. Provisional Application No. 62/981,659, filed Feb. 26, 2020, the content of which is incorporated herein by reference in its entirety.

### FIELD

The present disclosure relates generally to articles including and methods for making thin sheets on carriers and, more particularly, to articles including and methods for making thin glass sheets controllably bonded on glass carriers.

### BACKGROUND

Flexible substrates offer the promise of cheaper devices using roll-to-roll processing, and the potential to make thinner, lighter, more flexible and durable displays. However, the technology, equipment, and processes for roll-to-roll processing of high quality displays are not yet fully developed, particularly for lighter, thinner glass sheets. Since panel makers have already heavily invested in toolsets to process large sheets of glass, laminating a flexible substrate to a carrier and making display devices on the flexible substrate by sheet-to-sheet processing offers a shorter term solution to develop the value proposition of thinner, lighter, and more flexible displays. Displays have been demonstrated on polymer sheets, for example polyethylene naphthalate (PEN), where the device fabrication was sheet-to-sheet with the PEN laminated to a glass carrier. The upper temperature limit of the PEN limits the device quality and process that can be used. In addition, the high permeability of the polymer substrate leads to environmental degradation of organic light emitting diode (OLED) devices where a near hermetic package is beneficial. Thin film encapsulation offers a potential solution to overcome this limitation, but it has not yet been demonstrated to offer acceptable yields at large volumes.

In the case of thin, flexible glass, the lack of stiffness of the thin glass renders it difficult to handle during processing. In the past several years, various technologies have been developed to deal with this problem. These have largely relied on the temporary bonding of a thin glass (for example, Corning® Willow® glass) to a carrier glass which can be easily removed after processing. Processing challenges include thermal processing steps that can reach temperatures of 350° C. for amorphous silicon thin film transistors (a-Si TFTs), 400 to 450° C. for indium gallium zinc oxide (IGZO or Oxide TFT) or as high as 600° C. or greater for the processing of low temperature polysilicon (LTPS) devices. Vacuum and wet etch environments may also be used, further limiting the materials that may be used and placing high demands on the carrier and/or thin sheet.

Such glass-on-carrier methods are largely based on incorporating an ultrathin coating or a surface functionalization and/or modification onto a carrier glass (e.g. Corning® EAGLE XG® glass). Many of these ultrathin coatings employ organic or organometallic molecules that have been determined capable of withstanding the thermal processing challenges outlined above while maintaining their ability to be removed following processing.

Substrates with through glass vias (TGV) can also benefit from temporary bonding to carrier sheets. In order to take advantage of glass, and especially thin glass, for RF and interposer applications, it is beneficial to have precision vias (holes) for making electrical interconnections. In the case of TGVs, where through vias in glass may be filled with copper by electroplating, a substrate is often bonded temporarily to one side of the glass to render the through vias blind vias (i.e. the holes do not go all the way through). It is usually much easier to fill a blind via by bottom-up plating than completely filling a through via. Once the vias in the substrate on the carrier have been filled with a material of interest, the carrier glass can be removed from the substrate to provide a substrate with filled TGVs.

Both the thin glass on carrier and the TGV on carrier bonding technologies benefit from atomically smooth (for example, smooth sheet surfaces that are obtained without particular processes, for example polishing, to make the surfaces smooth) thin sheet surfaces to ensure sufficient bonding. Specifically, roughness on either of the thin sheets leads to lack of point-to-point contact, and thus weaker bonding. Surface roughness can be the result of common processing steps, for example etching processes. For example, for thin glass on carrier technologies, when either glass sheet (thin glass or carrier) has a surface roughness, Rq, of greater than 1 nm, bonding of the two sheets becomes increasingly difficult as the ultrathin coating (or modification layer) becomes thinner. In the case of TGV, often the etching process results in the formation of raised rims around the vias having a height of up to about 10 nm. Polishing of TGV substrates can result in additional surface roughness. The above-noted surface features (for example roughness, raised rim) prevent, or render difficult, successful bonding between sheets.

Accordingly, what is desired is a carrier approach that utilizes the existing capital infrastructure of the manufacturers, enables processing of glass sheets, e.g., thin sheets having a thickness ≤0.3 millimeters (mm) thick, without loss of bond strength between the thin sheet and carrier at higher processing temperatures, and wherein the thin sheet debonds easily from the carrier at the end of the process. The approach should allow for: a) artificial smoothing (for example planarizing with the modification layer) of a roughened thin sheet surface such that it is able to sufficiently bond to another thin sheet; b) spontaneous bonding between a carrier and a thin sheet at room temperature, preferably without the need for lamination processes, to provide sufficient bond, or adhesion energy on the order of 100-700 mJ/m²; c) subsequent wet and dry processing steps without detachment of the thin sheet from the carrier; d) ability for the bonded pair to withstand the thermal, chemical, vacuum and wet processing steps of fabrication; e) minimal outgassing during thermal processing; and f) ease of separation of the thin sheet from the carrier at the end of processing.

One commercial advantage is that manufacturers will be able to utilize existing processing equipment while gaining the advantages provided by thin sheets, e.g., thin glass sheets, for photovoltaic (PV), OLED, liquid crystal displays (LCDs) and patterned thin film transistor (TFT) electronics, for example. Additionally, such an approach enables process flexibility, including: processes for cleaning and surface preparation of the thin sheet and carrier to facilitate bonding without the need for additional investment of capital in acquiring, or time in using, chemical or mechanical polishing equipment.

### SUMMARY

In light of the above, there is a need for a thin sheet—carrier article that can utilize a roughened thin-sheet without any additional chemical or mechanical processing steps, while also withstanding the rigors of TFT and flat panel display (FPD) processing, including high temperature processing (without outgassing which would be incompatible with the semiconductor or display making processes in which it will be used) and allowing the entire area of the thin sheet to be removed (either all at once, or in sections) from the carrier so as to allow the reuse of the carrier for processing another thin sheet. The present specification describes methods to control the adhesion between the carrier and the roughened thin sheet to create a temporary bond sufficiently strong to survive thermal processing (including processing at temperatures of about 200° C., about 300° C., about 400° C., about 500° C., and up to about 600° C.), but weak enough to permit debonding of the sheet from the carrier, even after high-temperature processing. Such controlled bonding can be utilized to create an article having a reusable carrier. More specifically, the present disclosure provides surface modification layers (including various materials and associated surface heat treatments), that may be provided on the thin sheet, the carrier, or both, to smoothen out roughened glass surfaces while controlling both room-temperature van der Waals, and/or hydrogen bonding and/or electrostatic and high temperature covalent bonding between the thin sheet and carrier. Even more specifically, the present disclosure provides for a modification layer having one or more cationic layers and one or more anionic layers that, when applied to the surface of a carrier or a thin sheet, sufficiently smoothens out any roughness in the surface such that it will sufficiently bond to a thin sheet or a carrier sheet. These methods solve the problem of ineffective bonding that can occur using roughened thin sheets, while also producing bonding between the components such that the bonding energy is not too high, which might render the components inseparable after electronic device processing, and such that the bonding energy is not too low, which might lead to compromised bonding quality, thus leading to possible debonding or fluid ingress between the thin sheet and carrier during electronic device processing. These methods also produce an article that exhibits low outgassing and survives high temperature processing and/or other processing steps.

In a first aspect, there is an article comprising: a first glass sheet having a first glass sheet bonding surface, a second glass sheet having a second glass sheet bonding surface and a modification layer having a modification layer bonding surface, the modification layer coupling the first glass sheet and the second glass sheet. The modification layer comprises one or more cationic layers having one or more cationic polymers. The modification layer also comprises one or more anionic layers having one or more anionic polymers. Any one or more of the following examples of this first aspect may be combined with this first aspect in any and all combinations.

In an example of the first aspect, the cationic polymer is water soluble.

In yet another example of the first aspect, the cationic polymer comprises a polyalkyl backbone.

In another example of the first aspect, a repeating unit of the cationic polymer comprises one or more of a positively charged nitrogen, phosphorous, sulfur, boron or carbon.

In another example of the first aspect, the repeating unit of the cationic polymer comprises a positively charged nitrogen.

In another example of the first aspect, the positively charged nitrogen is an ammonium cation.

In another example of the first aspect, the repeating unit of the cationic polymer comprises

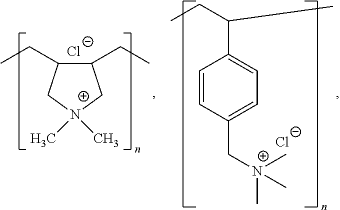

or combinations thereof.

In another example of the first aspect, the positively charged nitrogen is an imidazolium cation.

In another example of the first aspect, the repeating unit of the cationic polymer comprises

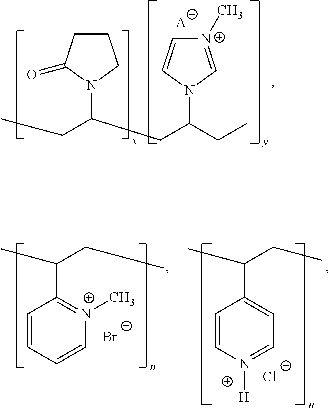

or combinations thereof.

In another example of the first aspect, the polymer is substantially free of oxygen.

In another example of the first aspect, the anionic polymer is water soluble.

In another example of the first aspect, the anionic polymer comprises a polyalkyl backbone.

In another example of the first aspect, a repeating unit of the anionic polymer comprises a negatively charged oxygen.

In another example of the first aspect, the repeating unit of the anionic polymer is a sulfonate anion.

In another example of the first aspect, the repeating unit comprises a polysulfate, a polyacrylate, or a polysulfonate anion.

In another example of the first aspect, the repeating unit comprises

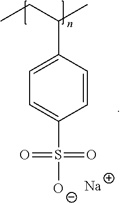

In an example of the first aspect, the article of any of the preceding claims

wherein the repeating unit of the cationic polymer comprises

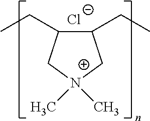

and the

repeating unit of the anionic polymer comprises

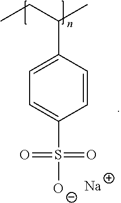

In an example of the first aspect, the modification layer comprises from two to twenty five total cationic and anionic layers.

In an example of the first aspect, the modification layer comprises less than ten total cationic and anionic layers.

In an example of the first aspect, the modification layer comprises an odd number of cationic layers.

In an example of the first aspect, the modification layer comprises an average thickness of from about 0.1 nm to about 100 nm.

In an example of the first aspect, the average thickness of the modification layer is from about 2 nm to about 10 nm.

In another example of the first aspect, the first glass sheet bonding surface is bonded with the second glass sheet bonding surface with a bond energy of from about 100 to about 800 mJ/m² after holding the article at 250° C. for 10 minutes followed by cooling the article to 150° C. over 45 minutes

In another example of the first aspect, the bond energy is from about 400 to about 600 mJ/m².

In another example of the first aspect, the average thickness of the first glass sheet is equal to or less than 300 micrometers (microns or μm).

In yet another example of the first aspect, the average thickness of the second glass sheet is equal to or greater than 200 microns.

In an example of the first aspect, the average thickness of the second glass sheet is greater than an average thickness of the first glass sheet.

In an example of the first aspect, the first glass sheet and/or the second glass sheet comprises a roughened surface prior to bonding.

In yet another example of the first aspect, the first glass sheet and/or the second glass sheet comprises an average roughness, Rq, of from about 0.1 nm to about 100 nm.

In yet another example of the first aspect, the average roughness of the first glass sheet and/or the second glass sheet is less than about 15 nm.

In yet another example of the first aspect, the average roughness of the first glass sheet and/or the second glass sheet is less than about 10 nm.

In an example of the first aspect, the average thickness of the modification layer is greater than or equal to the average roughness of the first and/or second sheet.

In another example of the first aspect, the average thickness of the modification layer is greater than the average roughness of the first and/or the second sheet.

In a second aspect there is a method of making a glass article comprising forming a modification layer on a bonding surface of a first glass sheet by depositing a cationic layer comprising a cationic polymer onto a bonding surface of the first glass sheet, depositing an anionic layer comprising an anionic polymer onto the cationic layer, and optionally repeating the first two steps such that the cationic polymer and anionic polymer are deposited in an alternating fashion. The modification layer has a glass bonding surface, which is then bonded to a bonding surface of a second glass sheet. Any one or more of the following examples of this second aspect may be combined with this second aspect in any and all combinations.

In an example of the second aspect, the method further comprises the step of debonding at least a portion of the modification layer bonding surface from the bonding surface of the first glass sheet and/or the second glass sheet.

In an example of the second aspect, the repeating unit of the cationic polymer comprises one or more of a positively charged nitrogen, phosphorous, sulfur, boron or carbon.

In another example of the second aspect, the repeating unit of the cationic polymer is selected from the group consisting of

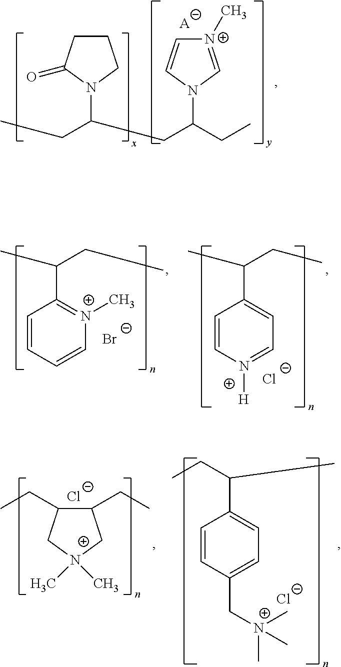

and combinations thereof.

In another example of the second aspect, the repeating unit of the anionic polymer comprises a polyacrylate, a polysulfate, or a polysulfonate.

In yet another example of the second aspect, the repeating unit of the anionic

polymer is

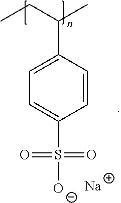

In another example of the second aspect, the repeating unit of the cationic

polymer comprises

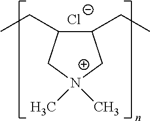

and the repeating unit of the anionic polymer

comprises

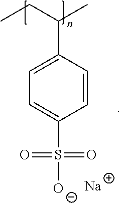

In another example of the second aspect, the first glass sheet and/or the second glass sheet comprises an average roughness of from about 0.1 nm to about 100 nm.

In another example of the second aspect, the first glass sheet and/or the second glass sheet comprises an average roughness of less than about 15 nm.

In another example of the second aspect, the first glass sheet and/or the second glass sheet comprises an average roughness of less than about 10 nm.

In another example of the second aspect, the method further comprises the step of O₂ plasma treatment of the first glass sheet and/or the second glass sheet prior to depositing the cationic polymer.

In another example of the second aspect, the method further comprises the step of washing the first glass sheet and/or the second glass sheet prior to depositing the cationic polymer.

In another example of the second aspect, the method further comprises the step of washing each polymer layer prior to depositing the next polymer layer.

In another example of the second aspect, the method further comprises a drying step.

In another example of the second aspect, the cationic polymer and the anionic polymer are deposited by spin coating, dip coating or spray coating.

In another example of the second aspect, the cationic polymer and/or the anionic polymer are deposited as an aqueous solution.

In another example of the second aspect, the aqueous solution of cationic and/or anionic polymer has a polymer concentration of from 0.001 weight percent to 0.5 weight percent.

In another example of the second aspect, the aqueous solution of cationic polymer has a polymer concentration of about 0.1 weight percent.

In another example of the second aspect, the aqueous solution of cationic and/or anionic polymer comprises a polymer concentration of from about 0.05 weight percent to about 0.2 weight percent

In another example of the second aspect, the aqueous solution of polymer is substantially free of organic solvent.

In another example of the second aspect, the method further comprises the step of roughening the glass sheets.

In yet another example of the second aspect, the first and/or second glass sheets are roughened by polishing or etching of the glass.

In another example second aspect, the modification layer comprises an average thickness of from about 0.1 nm to about 100 nm.

In another example of the second aspect the modification layer comprises an average thickness of from about 2 nm to about 10 nm.

In another example of the second aspect, the modification layer comprises from two to twenty five total cationic and anionic layers.

In an example of the second aspects, the modification layer comprises less than ten total cationic and anionic layers.

In an example of the second aspect, the modification layer comprises an odd number of cationic layers.

In an example of the first and/or second aspects, the average thickness of the modification layer is greater than or equal to the average roughness of the first glass sheet and/or the second glass sheet.

In an example of the first and/or second aspects, the average thickness of the modification layer is greater than the average roughness of the first glass sheet and/or the second glass sheet.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 is a schematic side view of an article having first sheet bonded to a second sheet with a modification layer there between, according to some embodiments.

FIG. 2 is an exploded and partially cut-away view of the article in FIG. 1.

FIG. 3 is a graph of the average thickness of the modification layer (nm, y-axis) as a function of the number of polymeric layers (x-axis) as measured by ellipsometry on Si wafer substrates.

### DETAILED DESCRIPTION

Example embodiments will now be described more fully hereinafter with reference to the accompanying drawings in which example embodiments are shown. Whenever possible, the same reference numerals are used throughout the drawings to refer to the same or like parts. However, the embodiments may take on many different forms and should not be construed as limited to those specifically set forth herein. These example embodiments are provided so that this disclosure will be both thorough and complete, and will fully convey the scope of the claims to those skilled in the art.

Directional terms as used herein (e.g., up, down, right left, front, back, top, bottom) are made only with reference to the figures as drawn and are not intended to imply absolute orientation.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, for example within about 5% of each other, or within about 2% of each other.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, a glass that is “free of” or “substantially free of B₂O₃,” for example, is one in which B₂O₃ is not actively added or batched into the glass, but may be present in very small amounts (e.g., <0.001 mol %) as a contaminant. Similar to B₂O₃, other components may be characterized as “free of” or “substantially free of” in the same manner.

Provided are solutions for allowing the processing of a first sheet coupled to a second sheet, whereby at least portions of the second sheet, for example, a thin sheet or a thin glass sheet, remain non-permanently bonded so that after devices (for example TFTs) are processed onto the thin sheet, the thin sheet may be removed from the first sheet, for example, a carrier. The solutions provided for herein are especially useful for thin sheets and/or carrier sheets that are roughened sheets, in particular, those sheets that have a surface roughness resulting from certain steps (e.g. etching) during glass sheet processing. In order to maintain advantageous surface shape characteristics, the carrier is typically a display grade glass substrate, for example Corning® EAGLE XG® alkali-free display glass. Accordingly, in some situations, it may be wasteful and expensive to merely dispose of the carrier after one use. Thus, in order to reduce costs of display manufacture, it is desirable to be able to reuse the carrier to process more than one thin sheet substrate. The present disclosure sets forth articles and methods for enabling a thin sheet to be processed through the harsh environment of the processing lines, for example TFT or LTPS, including high temperature processing, wherein high temperature processing is processing at a temperature ≥about 100° C., ≥about 200° C., ≥300° C., and up to about 400° C. and wherein the processing temperature may vary depending upon the type of device being made, for example, temperatures up to about 400° C. as in CF, a:Si or oxide TFT processing—and yet still allow the thin sheet to be easily removed from the carrier without damage (for example, wherein one of the carrier and the thin sheet breaks or cracks into two or more pieces) to the thin sheet or carrier, whereby the carrier may be reused. The articles and methods of the present disclosure can be applied to other high-temperature processing, for example, processing at a temperature in the range of 200° C. to 400° C., and yet still allow the thin sheet to be removed from the carrier without significantly damaging the thin sheet. Table 1 below sets forth peak temperatures and time cycles for a number of flat panel display (FPD) processing steps for which the article and method of the present disclosure may be useful.

TABLE 1
Peak Temperatures/Time Cycles for FPD Processes

| Technology | Peak Temp/Time | |
|---|---|---|
| CF (color filter) | 250° | C./2 hour |
| a: Si (amorphous silicon) | 350° | C./2 hour |
| OxTFT (oxide TFT) | 400° | C./1 hour |
| LTPS (low temperature poly-silicon) | 580° | C./10 minute |

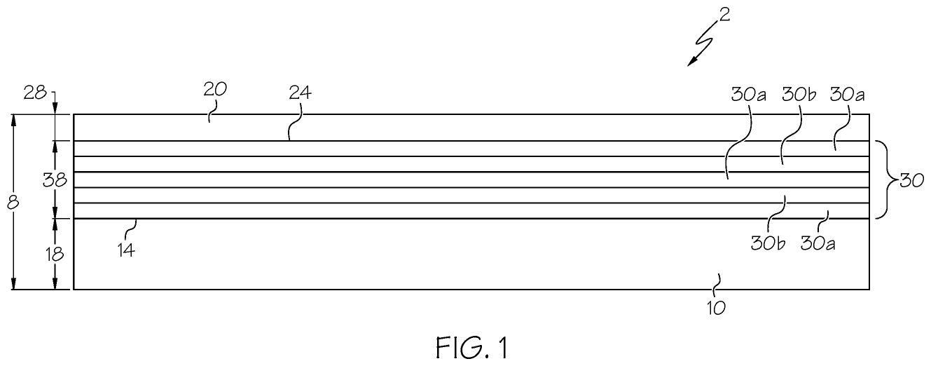

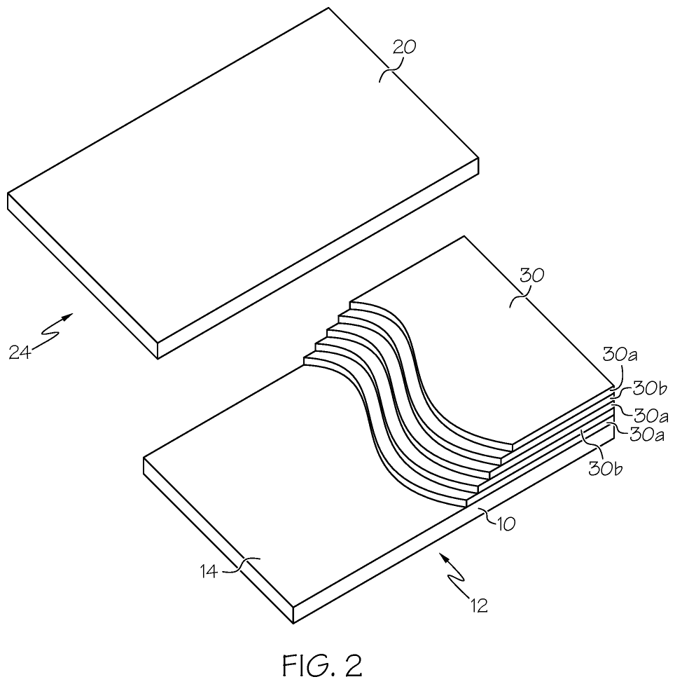

As shown in FIGS. 1 and 2, an article 2, for example a glass article, has a thickness 8. The article 2 comprises a first sheet 10 (for example a carrier) having a thickness 18, a second sheet 20 (e.g., a thin glass sheet) having a thickness 28, and a modification layer 30 having a thickness 38. The average thickness 28 of the thin sheet 20 may be, for example, equal to or less than about 300 micrometers (μm, or microns), including but not limited to thicknesses of, for example, about 10 to about 50 micrometers, about 50 to about 100 micrometers, about 100 to about 150 micrometers, about 150 to about 300 micrometers, about 300 micrometers, about 250 micrometers, about 200 micrometers, about 190 micrometers, about 180 micrometers, about 170 micrometers, about 160 micrometers, about 150 micrometers, about 140 micrometers, about 130 micrometers, about 120 micrometers, about 110 micrometers, about 100 micrometers, about 90 micrometers, about 80 micrometers, about 70 micrometers, about 60 micrometers, about 50 micrometers, about 40 micrometers, about 30 micrometers, about 20 micrometers, or about 10 micrometers, and any and all subranges between the foregoing endpoints.

The carrier 10 and/or the thin sheet 20 have bonding surfaces 14, 24. In some embodiments, one or both of the bonding surfaces 14, 24 may be roughened bonding surfaces. That is the bonding surfaces 14, 24 may not be atomically smooth surfaces. Roughened bonding surfaces 14, 24 on the carrier 10 and/or the thin sheet 20 may lead to lack of contact between the pair, and thus weak bonding or no bonding. For example, in the case of a thin sheet of Willow® glass and a carrier, if either the Willow® glass or the carrier has a roughness, Rq, greater than 1 nanometer, the pair can hardly be bonded. In the case of TGV, the via etching process can lead to the formation of raised rims around the vias that can measure 10 nanometers or more. Random roughness due to polishing can also be present on TGV substrates. The presence of any of these surface features on the carrier 10 and/or the thin sheet 20 can inhibit bonding of the glass sheets. The average roughness, Rq, of the thin sheet 20 and/or the carrier sheet 10 may be, for example, about 0.1 nanometers to about 1 micrometer, including but not limited to the roughness of, for example, about 1 micron or less, about 50 nanometers or less, about 25 nanometers or less, about 15 nanometers or less, about 10 nanometers or less, about 9 nanometers or less, about 8 nanometers or less, about 7 nanometers or less, about 6 nanometers or less, about 5 nanometers or less, about 4 nanometers or less, about 3 nanometers or less, about 2 nanometers or less, or about 1 nanometer or less.

The article 2 is arranged to allow the processing of thin sheet 20 in equipment designed for thicker sheets, for example, those having an average thickness on the order of greater than or equal to about 0.4 mm, for example about 0.4 mm, about 0.5 mm, about 0.6 mm, about 0.7 mm, about 0.8 mm, about 0.9 mm, or about 1.0 mm, although the thin sheet 20 itself is equal to or less than about 300 micrometers. The thickness 8 of the article 2, which is the sum of thicknesses 18, 28, and 38, can be equivalent to that of the thicker sheet for which a piece of equipment, for example equipment designed to dispose electronic device components onto substrate sheets, was designed to process. In an example, if the processing equipment was designed for a 700 micrometer sheet, and the thin sheet had a thickness 28 of about 300 micrometers, then thickness 18 would be selected as about 400 micrometers, assuming that thickness 38 is negligible. That is, the modification layer 30 is not shown to scale, but rather it is greatly exaggerated for sake of illustration only.

Additionally, in FIG. 2, the modification layer 30 is shown in cut-away. The modification layer 30 can be disposed uniformly, or substantially uniformly, over the bonding surface 14 when providing a reusable carrier. Although the modification layer 30 is shown as a solid layer between sheet 20 and sheet 10, such need not be the case. The modification layer 30 can also be spot-applied for certain applications if appropriate such that the modification layer 30 may not completely cover the entire portion of the bonding surface 14. For example, the coverage on either or both of the bonding surfaces 14, 24 may be ≤about 100%, from about 1% to about 100%, from about 10% to about 100%, from about 20% to about 90%, or from about 50% to about 90% of the bonding surface 14, including any ranges and subranges there between. Typically, the average thickness of the modification layer 38 will be on the order of nanometers (nm), for example from about 0.1 nm to about 1 micrometers, for example, from about 2 nm to about 250 nm, or from about 3 nm to about 100 nm, or about 2 nm, about 3 nm, about 4 nm, about 5 nm, about 6 nm, about 7 nm, about 8 nm, about 9 nm, about 10 nm, about 20 nm, about 30 nm, about 40 nm, about 50 nm, about 60 nm, about 70 nm, about 80 nm or about 90 nm, including any and all sub-ranges between any of the foregoing values. In certain embodiments, the average thickness 38 of the modification layer 30 is greater than or equal to the average roughness of the bonding surface of a thin sheet 24 and/or the average surface roughness of the carrier sheet 14. In some embodiments, the average thickness 38 of the modification layer 30 is greater than the average roughness of the bonding surface of a thin sheet 24. The presence of a modification layer may be detected by surface chemistry analysis, for example by time-of-flight secondary ion mass spectrometry (ToF SIMS) or X-ray photoelectron spectroscopy (XPS).

The modification layer 30 may be considered to be disposed between sheet 10 and sheet 20 even though it may not contact one or the other of sheet 10 and sheet 20. In other embodiments, the modification layer 30 modifies the ability of the bonding surface 14 to bond with bonding surface 24, thereby controlling the strength of the bond between the sheet 10 and sheet 20. The material and thickness of the modification layer 30, as well as the treatment of the bonding surfaces 14, 24 prior to bonding, can be used to control the strength of the bond (energy of adhesion) between sheet 10 and sheet 20.

First sheet 10 having a first sheet bonding surface 14 and a thickness 18 may be used as a carrier, for example. The first sheet 10 may be of any suitable material, including glass. The first sheet can be a non-glass material, for example, ceramic, fused silica, glass-ceramic, silicon, metal, or combinations thereof (as the surface energy and/or bonding may be controlled in a manner similar to that described below in connection with a glass carrier). If made of glass, first sheet 10 may be of any suitable composition including alumino-silicate, boro-silicate, alumino-boro-silicate, soda-lime-silicate, and may be either alkali-containing or alkali-free depending upon its ultimate application. Further, in some examples, when made of glass, glass-ceramic, or other material, the first sheet bonding surface can be made of a coating or layer of metal material disposed on the underlying bulk material of the first sheet. Thickness 18 may be from about 0.2 to about 3 mm, or greater, for example about 0.2 mm, about 0.3 mm, about 0.4 mm, about 0.5 mm, about 0.6 mm, about 0.65 mm, about 0.7 mm, about 1.0 mm, about 2.0 mm, or about 3.0 mm, or greater, including any and all subranges between the foregoing values, and will depend upon the thickness 28, and thickness 38 when thickness 38 is non-negligible, as noted above. The average thickness 18 of the first sheet 10 in some embodiments may be greater than the thickness 28 of the thin sheet 20. In some embodiments, thickness 18 may be less than thickness 28. In some embodiments, the first sheet 10 may be made of one layer, as shown, or multiple layers (including multiple thin sheets) that are bonded together. Further, the first sheet may be of a Gen 1 size or larger, for example, Gen 2, Gen 3, Gen 4, Gen 5, Gen 8 or larger (e.g., sheet sizes from about 100 mm×100 mm to about 3 meters×3 meters or greater).

The thin sheet 20 having a bonding surface 24 and a thickness 28 may be of any suitable material including glass, ceramic, glass-ceramic, silicon, metal or combinations thereof. As described above for the first sheet 10, when made of glass, thin sheet 20 may be of any suitable composition, including alumino-silicate, boro-silicate, alumino-boro-silicate, soda-lime-silicate, and may be either alkali containing or alkali-free depending upon its ultimate application. The coefficient of thermal expansion of the thin sheet can be matched substantially the same with that of the first sheet to reduce any warping of the article during processing at elevated temperatures. The average thickness 28 of the thin sheet 20 is about 300 micrometers or less, as noted above, for example about 200 micrometers or about 100 micrometers. Further, the thin sheet may be of a Gen 1 size or larger, for example, Gen 2, Gen 3, Gen 4, Gen 5, Gen 8 or larger (e.g., sheet sizes from about 100 mm×100 mm to about 3 meters×3 meters or greater).

The article 2 can have a thickness that accommodates processing with existing equipment, and likewise it can survive the harsh environment in which the processing takes place. For example, CF processing may be carried out at high temperature (e.g., ≥about 250° C.). Processing temperatures for amorphous Si may reach 350° C. or oxide TFT processing temperatures may reach up to 400-450° C. For some processes, as noted above, the temperature may be ≥about 200° C., ≥about 250° C., ≥about 300° C., ≥about 350° C., and up to about 400° C., including any ranges and subranges there between.

To survive the harsh temperatures in which article 2 may be processed, the bonding surface 14 should be bonded to bonding surface 24 with sufficient strength so that the thin sheet 20 does not spontaneously separate from first sheet 10. This strength should be maintained such that sheet 20 does not separate from sheet 10 during processing. Further, to allow sheet 20 to be removed from sheet 10 (so that a carrier may be reused, for example), the bonding surface 14 should not be bonded to bonding surface 24 too strongly either by the initially designed bonding force, and/or by a bonding force that results from a modification of the initially designed bonding force as may occur, for example, when the article undergoes processing at high temperatures, e.g., temperatures of ≥about 200° C., ≥about 250° C., ≥about 300° C., ≥about 350° C., and up to about 400° C. The modification layer 30 may be used to control the strength of bonding between bonding surface 14 and bonding surface 24 so as to achieve both of these objectives by controlling the contributions of van der Waals (and/or hydrogen bonding) and covalent attractive energies between the modification layer 30 and the first sheet 10 and/or second sheet 20. This controlled bonding is strong enough to survive CF or a:Si processing, for instance, including temperatures ≥about 200° C., ≥about 300° C., ≥about 350° C., and ≥about 400° C., and remain debondable by application of a force sufficient to separate the sheets but not cause significant damage to sheet 20 and/or sheet 10. For example, in some embodiments, the applied force should not break either sheet 20 or sheet 10. Such debonding permits removal of sheet 20 and the devices fabricated thereon, and also allows for re-use of sheet 10 as a carrier.

Deposition of the Modification Layer

One of the advantages of the cationic and anionic polymers used in according to the present disclosure is that the polymer layers can be applied through a simple, one-step processing to enable spontaneous bonding between the carrier and the thin sheet at room temperature whenever possible. The ionic polymers described herein are highly hydrophilic due to the strong interactions between the charges along the polymer chains and the dipoles of the water molecules. Therefore, the glass surface coated with these polymers will remain highly hydrophilic and have a high surface energy matching, or nearly matching, that of bare glass (approximately 75 mJ/m²). This may obviate the need for pressure lamination techniques to bond the surfaces or for energy-enhancing plasma treatment to increase the surface energy of the modification layer as is often the case with organic polymers.

Because of their highly hydrophilic and water soluble nature, ionic polymers allow for simplified application onto the first and/or second sheets. An aqueous solution of the polymer can be made and then the first and/or second sheets can be treated by a variety of simple dispensing methods, for example spin coating, dip coating, spray coating, and combinations thereof. Aqueous processing also advantageously avoids the need for organic solvents, thereby decreasing the cost and environmental impact.

Bonding Energy of the Second or Thin Sheet with the Modification Layer

As referred to herein, the bond energy of the modification layer 30 is a measure of the force coupling the thin sheet 20 and the carrier 10. In general, the energy of adhesion (i.e., bond energy) between two surfaces can be measured by a double cantilever beam method or wedge test. The tests simulate in a qualitative manner the forces and effects on an adhesive bond joint at the interface between modification layer 30 and second sheet 20. Wedge tests are commonly used for measuring bonding energy. For example, ASTM D5041, Standard Test Method for Fracture Strength in Cleavage of Adhesives in Bonded Joints, and ASTM D3762, Standard Test Method for Adhesive-Bonded Surface Durability of Aluminum, are standard test methods for measuring bonding of substrates with a wedge.

A summary of the test method for determining bond energies as disclosed herein, based on the above-noted ASTM methods, includes recording of the temperature and relative humidity under which the testing is conducted, for example, that in a lab room. The second sheet is gently pre-cracked or separated at a corner of the glass article to break the bond between the first sheet and the second sheet. A sharp razor is used to pre-crack the second sheet from the first sheet, for example, a GEM brand razor with a thickness of about 95 microns. In forming the pre-crack, momentary sustained pressure may be used to fatigue the bond. A flat razor having the aluminum tab removed is slowly inserted until the crack front can be observed to propagate such that the crack and separation increases. The flat razor does not need to be inserted significantly to induce a crack. Once a crack is formed, the glass article is permitted to rest for 5 minutes or more to allow the crack to stabilize. Longer rest times may be used for high humidity environments, for example, above 50% relative humidity.

The glass article with the developed crack is evaluated with a microscope to record the crack length. The crack length is measured from the end separation point of the second sheet from the first sheet (i.e. furthest separation point from the tip of razor) and the closest non-tapered portion of the razor. The crack length is recorded and used in the following equation to calculate bond energy.

γ=3t_{b}²E₁t_{w1}³E₂t_{w2}³/16L⁴(E₁t_{w1}³+E₂t_{w2}³) (7)

wherein γ represents the bond energy, t_{b} represents the thickness of the blade, razor or wedge, E₁ represents the Young's modulus of the first sheet 10 (e.g., a glass carrier), t_{w1} represents the thickness of the first sheet, E₂ represents the Young's modulus of the second sheet 20 (e.g., a thin glass sheet), t_{w2} represents the thickness of the second sheet 20 and L represents the crack length between the first sheet 10 and second sheet 20 upon insertion of the blade, razor or wedge as described above.

The bond energy is understood to behave as in silicon wafer bonding, where an initially hydrogen bonded pair of wafers are heated to convert much or all the silanol-silanol hydrogen bonds to Si—O—Si covalent bonds. While the initial room temperature hydrogen bonding produces bond energies on the order of about 100-200 mJ/m² which allows separation of the bonded surfaces, a fully covalently bonded wafer pair as achieved during processing on the order of about 300 to about 800° C. has an adhesion energy of about 2000 to about 3000 mJ/m², which does not allow separation of the bonded surfaces; instead, the two wafers act as a monolith. On the other hand, if both the surfaces are perfectly coated with a low surface energy material, for example a fluoropolymer, with a thickness large enough to shield the effect of the underlying substrate, the adhesion energy would be that of the coating material and would be very low, leading to low or no adhesion between the bonding surfaces 14, 24. Accordingly, the thin sheet 20 would not be able to be processed on sheet 10 (for example a carrier) without failure of the bond and potential damage to the thin sheet 20. Consider two extreme cases: (a) two standard clean 1 (SC1, as known in the art) cleaned glass surfaces saturated with silanol groups bonded together at room temperature via hydrogen bonding (whereby the adhesion energy is about 100 to about 200 mJ/m²) followed by heating to a temperature that converts the silanol groups to covalent Si—O—Si bonds (whereby the adhesion energy becomes about 2000 to about 3000 mJ/m²). This latter adhesion energy is too high for the pair of glass surfaces to be detachable; and (b) two glass surfaces perfectly coated with a fluoropolymer with low surface adhesion energy (about 12 to about 20 mJ/m² per surface) bonded at room temperature and heated to high temperature. In this latter case (b), not only do the surfaces not bond at low temperature (because the total adhesion energy of from about 24 to about 40 mJ/m², when the surfaces are put together, is too low), they do not bond at high temperature either as there are too few polar reacting groups. Between these two extremes, a range of adhesion energies exist, for example from about 50 to about 1000 mJ/m², which can produce the desired degree of controlled bonding. Accordingly, the inventors have found various methods of providing a modification layer 30 leading to a bonding energy between these two extremes, and such that there can be produced a controlled bonding sufficient to maintain a pair of substrates (for example a glass carrier or sheet 10 and a thin glass sheet 20) bonded to one another through the rigors of CF, a-Si or ox TFT processing but also of a degree that (even after high temperature processing of, e.g. ≥about 200° C., ≥about 300° C., and up to about 400° C.) allows the detachment of sheet 20 from sheet 10 after processing is complete. Moreover, the detachment of the sheet 20 from sheet 10 can be performed by mechanical forces, and in such a manner that there is no significant damage to at least sheet 20, and preferably also so that there is no significant damage to sheet 10.

An appropriate bonding energy can be achieved by using select surface modifiers, i.e., modification layer 30, and/or thermal treatment of the surfaces prior to bonding. The appropriate bonding energy may be attained by the choice of chemical modifiers of either one or both of bonding surface 14 and bonding surface 24, which chemical modifiers control both the van der Waals (and/or hydrogen bonding, as these terms are used interchangeably throughout the specification) adhesion energy as well as the likely covalent bonding adhesion energy resulting from high temperature processing (e.g. ≥about 200° C., ≥about 300° C., and up to about 400° C.).

Production of the Article

In order to produce the article 2, for example a glass article, the modification layer 30 is formed on one of the sheets, preferably the first sheet 10 (for example, a carrier). If desired, the modification layer 30 can be subjected to steps for example surface activation and annealing in order increase the surface energy, decrease outgassing during processing and improve the bonding capabilities of the modification layer 30, as described herein. In order to bond the other sheet, for example thin sheet 20, the other sheet is brought into contact with the modification layer 30. If the modification layer 30 has a high enough surface energy, introducing the other sheet to the modification layer 30 will result in the other sheet being bonded to the modification layer 30 via a self-propagating bond. Self-propagating bonds are advantageous in reducing assembly time and/or cost. However, if a self-propagating bond does not result, the other sheet can be bonded to the modification layer 30 using additional techniques, for example lamination processes, for example by pressing the sheets together with rollers, or by other techniques for bringing two pieces of material together for bonding.

In order to produce an article 2 according to the above-mentioned process, it is desirable that the first sheet 10 and the second sheet 20 contain atomically smooth bonding surfaces 14, 24, because increased roughness leads to a lack of surface-to-surface contact and, therefore, inadequate bonding.

It has been found that an article including a roughened first sheet 10 and/or a roughened second sheet 20 (for example a carrier 10 and a thin sheet 20), suitable for CF, a-Si or ox TFT, for example, (including processing at temperatures of ≥about 200° C., ≥about 300° C., and up to about 400° C.), can be made by coating the first sheet 10 and/or second sheet 20 with alternating cationic 30a and anionic 30b polymer layers.

An advantage of the polymers disclosed herein is that many of them provide a modification layer 30 having a bonding surface with a surface energy of greater than 70 mJ/m², as measured for one surface (including polar and dispersion components), which is sufficiently high to spontaneously bond with the glass surface via a self-propagating wave. Bare glass has a surface energy >75 mJ/m² as measured by contact angle. In some cases, the polycationic polymer may provide a surface that produces weak bonding due to a lower than optimal surface energy. Similarly, when a surface other than glass is used, it may be desirable to increase the surface energy of the bonding surface prior to bonding. In other words, the desired surface energy for bonding may not be the surface energy of the initially deposited polycationic polymer modification layer. In order to increase the surface energy when desired, the deposited layer may be further treated. As initially deposited, and without further processing, the modification layer 30 can show good thermal stability, however, it may not be sufficient to promote good, temporary bonding to the thin sheet 20. Because these surface energies may be low to promote temporary bonding to bare glass or to other desirable surfaces, surface activation of the modification layer may be beneficial to promote glass bonding. If necessary, surface energy of the deposited polycationic polymer layers can be raised to about or greater than 70 mJ/m² for glass bonding by plasma exposure to N₂, N₂—H₂, N₂—O₂, NH₃, N₂H₄, HN₃, CO₂, or mixtures thereof. The energy (after plasma treatment) may be high enough that the two surfaces bond one another, via the modification layer.

In some embodiments, the modification layer 30 is formed by the deposition of a cationic polymer layer 30a onto either or both of the bonding surface of the first sheet 14 or the bonding surface of the second sheet 24, followed by the deposition of an anionic polymer layer 30b on top of the cationic polymer layer 30a. In some embodiments, the modification layer can be formed by the deposition of an anionic polymer layer 30b onto one or both of the glass sheet bonding surfaces 14, 24 followed by the deposition of a cationic polymer layer 30a on the anionic polymer layer 30b. In further embodiments, the deposition process may be repeated, with cationic and anionic polymer layers 30a, 30b being deposited in an alternating fashion (e.g. cationic layer-anionic layer-cationic layer and/or anionic layer-cationic layer-anionic layer). For example, glass substrates typically carry a negative (anionic) surface charge in an aqueous medium at pH >2. When a cationic polymer 30a is deposited onto the anionic carrier bonding surface 14, electrostatic forces strongly bond the cationic polymer layer 30a to the substrate surface 14 and reverse the polarity of the surface rendering it cationic. The carrier can then be treated with a layer of anionic polymer 30b, which will strongly bond to the now-positively charged surface. This process of alternating cationic and anionic layer deposition can be repeated until a desired modification layer thickness 38 and/or carrier 14 and/or thin sheet surface 24 smoothness is achieved. In some embodiments, modification layer 30 consists of alternating layers of first and second layers, the first layer being a monolayer of the cationic polymers 30a and the second layer being a monolayer of the anionic polymers 30b.

In order to utilize the charged polymers of the present disclosure as modification layers 30 having sufficient thickness 38 to overcome any surface roughness of the glass sheets, it is necessary to build up the modification layer 30 to the desired thickness 38 by applying thinner layers of alternating charge. Without wishing to be bound by theory, it is believed that since identically charged polymers repel each other, application of a thicker layer of a single charged polymer (i.e. a thicker layer of an anionic polymer alone or a thicker layer of a cationic polymer alone) would not function as desired. That is, the polymeric layer may not adequately adhere to the glass surface or to itself when present in a single thicker layer. By alternating thinner layers of oppositely charged polymers, a more suitable modification layer 30 can be obtained having sufficient thickness 38 to even out any surface roughness and provide a planar, or substantially planar, surface to which the glass sheets can bond.

In some embodiments, the modification layer 30 may have an even number of total cationic and anionic polymer layers 30a, 30b. In some embodiments, the modification layer 30 may have an odd number of total cationic and anionic polymer layers 30a, 30b. For example, the modification layer 30 may contain from two to twenty five total cationic and anionic layers. In certain aspects, the modification layer comprises 2 or more, 3 or more, 4 or more, 5 or more, 6 or more, 7 or more, 8 or more, 9 or more or 10 or more polymeric layers.

The polycationic polymers according to the present disclosure can include any polycation-based polymer that is as thermally stable as possible and that is suitable for a liquid- or solution-based surface treatment and/or coating process. In particular, polycationic polymers that are water soluble and/or hydrophilic are particularly preferred. Polycationic polymers having a polyalkyl backbone are particularly preferred. Also preferred are polycationic polymers comprising aromatic groups, which have higher thermal stability generally. Polycationic repeating units can comprise one or more of a positively charged nitrogen, phosphorous, sulfur, boron, or carbon. In particular are polycationic repeating units comprising primary, secondary, tertiary, or quaternary ammonium cations, imidazolium cations, pyridinium cations, pyrimidinium cations, pyrrole cations, imidazolium cations, iminium cations, phosphonium ions, sulfonium ions, or combinations thereof. Particularly preferred are polycationic repeating units comprising positively charged nitrogens, especially ammonium, pyridinium, and imidazolium cations. In some embodiments, the repeating unit of the polymer comprises a ratio of carbon:nitrogen of from 2:1 to 20:1, or from 3:1 to 15:1, or from 3:1 to 12:1. In some embodiments, the cationic polymer is free, or substantially free, of oxygen.

Similarly, the polyanionic polymers according to the present disclosure include any polyanion-based polymer that is as thermally stable as possible and that is suitable for a liquid- or solution-based surface treatment and/or coating process. Specifically, water-soluble and/or hydrophilic polyanionic polymers are preferred. In some embodiments, the repeating unit of anionic polymer contains a negatively charged oxygen, sulfur, nitrogen, or phosphorus. In some embodiments, the repeating unit of anionic polymer contains a negatively charged oxygen. In addition, polyanionic repeating units consisting of repeating units comprising polyacrylate ions, polysulfate ions, sulfonate ions, or combinations thereof are also preferred. Particularly preferred are sulfonate anions.

In one example of cationic polymer deposition, the modification layer 30 can be formed by the deposition of a polymer comprising an ammonium cation. The ammonium cation can be a primary, secondary, tertiary or quaternary ammonium cation. In the cases of a secondary, tertiary or quaternary ammonium cation, the nitrogen can be substituted with a wide variety of substituents, including but not limited to alkyl, vinyl, allyl or amino, and glycidyl. Each substituent can be further substituted or unsubstituted, protected, or unprotected. Where an alkyl substituent is selected, the substituent may be branched or unbranched, saturated or unsaturated. Examples of alkyl groups include methyl, ethyl, n-propyl, iso-propyl, n-butyl, iso-butyl, tert-butyl, n-hexyl, n-decyl, tetradecyl, and the like. Methyl and ethyl substitution is particularly preferred. In one example, the polymer can be poly(diallyldimethylammonium chloride) (PDADMAC) (I), or other comparable salt or derivative thereof. In another example, the polymer can be poly(vinylbenzyl trimethyl ammonium chloride) (PVBTACl) (II), or other comparable salt or derivative thereof. It is believed that the ring structures of PDADMAC and PVBTACl help to impart thermal stability.

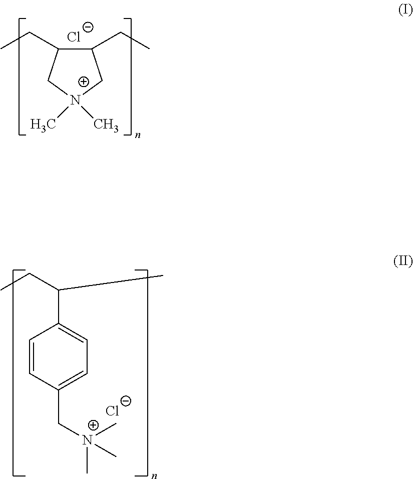

In another example, the modification layer 30 can be formed by the deposition of a cationic polymer comprising a pyridinium cation. As described above, the aromatic ring of the pyridine or pyrrole can further include any suitable number of substituents covalently bonded to one or more of the ring carbons and/or the nitrogen, and can be independently selected from H, alkyl, vinyl, allyl, amino, glycidyl, and thiol. Each substituent can be further substituted or unsubstituted, protected, or unprotected. Where an alkyl substituent is selected, the substituent may be branched or unbranched, saturated or unsaturated. Examples of alkyl groups include methyl, ethyl, n-propyl, iso-propyl, n-butyl, iso-butyl, tert-butyl, n-hexyl, n-decyl, tetradecyl, and the like. Preferred examples of polymers containing pyridinium cations include poly(4-vinyl-1-methylpyridinium bromide) (PVMPyBr) (III) and poly(4-vinylpyridine hydrochloride) (PVPyCl) (IV). Both of these polymers were selected due to the presence of a quaternary nitrogen in an aromatic ring, which is believed to increase thermal stability.

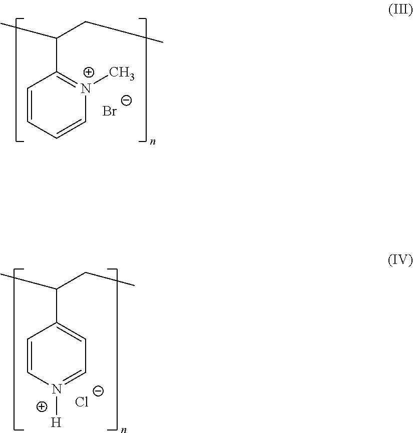

In yet another example, the modification layer 30 can be formed by the deposition of a cationic polymer comprising an imidazolium cation. As described above, an imidazole can be substituted or unsubstituted with a wide variety of suitable substituents covalently bonded to the ring structure. A preferred example of a polymer comprising an imidazolium cation is LUVIQUAT FC 550 (BASF) (V), a quaternary copolymer of 1-vinylpyrrolidone and 3-methyl-1-vinylimidazolium chloride. LUVIQUAT was selected for the present application due to the combination of the imidazolium ring and the vinylpyrrolidone.

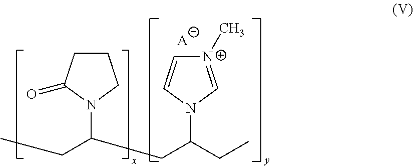

An advantage of the anionic polymers disclosed herein is that they are capable of binding strongly to cationic surfaces, for example glass comprising a cationic polymer layer for example those disclosed herein. In one example of anionic polymer deposition, the modification layer 30 can be formed by the deposition of a polymer comprising a negatively charged oxygen. In some embodiments, the modification layer 30 can be formed by the deposition of a polymer comprising a polysulfate anion. In another example, the modification layer 30 can be formed by the deposition of a polymer comprising a polyacrylate anion. In some embodiments, the modification layer 30 can be formed by the deposition of a polymer comprising a polysulfonate anion. A preferred example of an anionic polymer comprising a polysulfonate anion is poly(sodium-4-styrene sulfonate) (“PSS”).

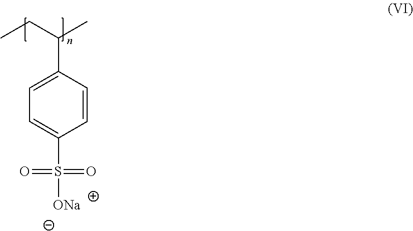

The use of a surface modification layer 30, together with bonding surface preparation as appropriate, can achieve a controlled bonding area, that is a bonding area capable of providing a room-temperature bond between sheet 20 and sheet 10 sufficient to allow the article 2 to be processed in CF, a-Si or ox TFT-type processes, and yet maintains controlled covalent bonding between sheet 20 and sheet 10 even at elevated temperatures so as to allow the sheet 20 to be removed from sheet 10, preferably without damage to the sheets, after high temperature processing of the article 2. Following thermal treatment, it is desirable for most of, substantially all of, or all of the modification layer 30 to remain on the carrier 10 after debonding. The presence of a modification layer 30 on a sheet may be detected by surface chemistry analysis, for example by time-of-flight secondary ion mass spectrometry (ToF SIMS) or X-ray photoelectron spectroscopy (XPS) to measure, for example, the percent of atomic carbon present on the carrier bonding surface 14 following polymer treatment before bonding and again after debonding following thermal treatment. Desirably, all, or substantially all, of the polymer remains on the carrier following debonding. In some embodiments, a portion of the polymer, or a portion of the modification layer bonding surface, is debonded from the carrier following thermal treatment. That is, the percent change in carbon content (as from carbon content coming off of the carrier and onto the thin sheet) of the carrier before bonding and after debonding is desirably less than about 30%, less than about 25%, less than about 20%, less than about 15%, less than about 10%, less than about 5%, less than about 3%, less than about 2% or less than about 1%. Similarly, the percent change in carbon content of the thin sheet before bonding and after debonding (as from carbon coming off of the modification layer and onto the thin sheet) is also preferably less than about 20%, less than about 15%, less than about 10%, less than about 5%, less than about 3%, less than about 2% or less than about 1%.

Advantageously, the use of a surface modification layer 30 can planarize, or smoothen out, roughened bonding surfaces of carrier 10 and/or thin sheet 20, thereby promoting more complete contact between the surfaces 14, 24, and thus stronger bonding between the sheets. To evaluate potential bonding surface 14, 24 preparations, and modification layers 30 with various bonding energies, that would provide a reusable carrier suitable for processing including thermal treatment, a series of tests were used to evaluate the suitability of each. Tests representative of lower temperature thermal processing were chosen, as these are desired applications for the article 2. Accordingly, the following testing was carried out to evaluate the likelihood that a particular bonding surface preparation and modification layer would allow a thin sheet 20 to remain bonded to a carrier 10 throughout processing, while allowing the thin sheet 20 to be removed from the carrier 10 (without damaging the thin sheet and/or the carrier) after such processing.

Thermal Testing of Bond Energy

Surface modification layers can be used to couple a thin sheet to a carrier at room temperature. For example, thin glass can bond very well to polycationic polymer modification layer bonding surfaces with a high bond speed consistent with the high surface energy. As used herein, a modification layer bonding surface is the surface of the modification layer that will be in contact with the coupled sheet, that is, the thin sheet, following coupling.

The bonding energy of the modification layers to thin sheets, e.g., thin glass sheets, was tested after specific heating conditions. To see whether a particular surface modification layer 30 would allow a thin sheet 20 to remain bonded to a carrier 10 and still allow the thin sheet 20 to be debonded from the carrier 10 after thermal processing.

For applying the modification layer 30 to one or both of the sheets, in particular sheets having one or more roughened bonding surfaces, a typical wash procedure was used without the need to modify in-line facilities. Typical washing includes use of detergents, spinning, rinsing and drying. Instead of using detergents, in some embodiments the polycationic polymer at concentrations varying from 0.0005 wt. % to 5 wt. %, and in particular 0.1 wt. %, was included in the detergent tank and sprayed on the glass surface. A flow average of 25 liters per minute was applied to draw the polycationic polymer solution to the carrier glass surface 14. The carrier glass surface 14 was then rinsed with water at a 25 liter per minute flow rate to remove excess polycationic polymer. The treated glass surface was then dried. A typical wash procedure was then used on the polycationic coated and dried glass surface. In some embodiments, the polyanionic polymer at concentrations varying from 0.005 wt. % to 5 wt. %, and in particular 0.1 wt. %, was included in the detergent tank and sprayed on the first cationic polymer layer 30a. A flow average of 25 liters per minute was applied to draw the polyanionic polymer solution to the carrier glass surface 14. The coated glass surface was then rinsed with water at a 25 liter per minute flow rate to remove excess polyanionic polymer and dried. This layering process can be repeated until the polymeric layers provide the desired planarization to the carrier glass surface 14. After drying, the coated carrier glass 10 was bonded to a thin sheet of Willow® glass 20 of substantially the same size to create the glass article 2. The article 2 was then heated in a tube furnace or a Rapid Thermal Processing (RTP) chamber that ramped to the desired processing-test temperature at a rate of 4° C. per second. The article was then held in the furnace (maintained at the desired processing-test temperature) for 10 minutes. The furnace was then cooled to about 150° C. within 45 minutes, and the sample was pulled and cooled to room temperature for further testing.

After room temperature bonding, the articles were then thermally tested to determine the bond energy after thermal processing by using the above-described thermal testing of bond energy. The bond energy of thin glass bonded with cationic polymer modification layers ranged from about 200 to about 450 mJ/m² prior to thermal processing and increased to about 400 to about 600 mJ/m² after thermal treatment at 250° C. Thus, the surface modification layers can consistently maintain a bond energy about 700 mJ/m² or less, about 650 mJ/m² or less, about 600 mJ/m² or less, about 550 mJ/m² or less, about 500 mJ/m² or less, about 450 mJ/m² or less, or about 400 mJ/m² or less with the thin glass sheet even after processing at about 100° C., about 200° C., about 300° C. or up to about 400° C., e.g., upon holding the glass article in an inert atmosphere that is at about 100° C., about 200° C., about 300° C. or up to about 400° C. for about 10 minutes, according to the thermal testing of bond energy.

### Examples

Surface Treatment with PDADMAC and PSS—Wafer/Spin Coating

Carrier glass sheets (EAGLE XG®, (available from, Corning Incorporated, Corning N.Y.) (0.5 mm) measuring 2 inches by 2 inches were first roughened via etching and/or leaching to have a roughness, Rq, from 2.7 nm to 3.3 nm, and were then treated with O₂ plasma for 5 minutes, followed by a rinse (or wash) step using hydrogen peroxide: JTB100 (ammonia) cleaner (JT Baker Chemicals): H₂O (2:1:40) solution for 10 minutes. After cleaning, the carrier sheets were spin-rinse-dried.

Layers of cationic (PDADMAC, MW: 400,000-500,000) and anionic (PSS, MW: 70,000) polymers were spin coated (30 seconds at 300 rpm, followed by 1 minute at 2000 rpm) on carrier sheets, with the cationic polymer applied first so to be in contact with the glass surface. Dilute solutions of both the PDADMAC (0.1 wt. %) and PSS (0.1 wt. %) were used for spin coating. After the application of each layer, the carriers were spin-rinsed with deionized water (30 seconds at 300 rpm; 1 minute at 2000 rpm) to wash off the excess polymer. After deposition of the desired number of total layers, the carrier sheets were placed on a hot plate (150° C.) for 2 minutes to dry.

The procedure of Example 1, as set forth above, was performed to prepare two samples: one containing five alternating polymeric layers (cationic, anionic, cationic, anionic, cationic) (Example 1), and the other containing seven polymeric layers (cationic, anionic, cationic, anionic, cationic, anionic, cationic) (Example 2). After each sample was dried on a hot plate, each sample was bonded with a 6-inch thin sheet or thin glass (Willow® glass) by bringing the thin glass sheet into optical contact with the coated carrier glass sheet and applying pressure at the mid-point of the pair. A control sample was also prepared by directly bonding a 2 inch by 2 inch roughened Corning EAGLE® XG alkali-free display glass sheet onto a 6-inch thin sheet following cleaning. The roughness of the control sample carrier glass also measured approximately 3 nanometers.

No self-propagation was observed for Example 1 comprising five polymeric layers and only a small area was bonded following initial contact. The glass pairs were laminated using a commercial laminator (Catena 65, GBC®) to simulate roll-to-roll processing. Lamination pressure was modified by changing the distance (Δx) of the silicone rollers. Following lamination, a fully bonded glass article was obtained. The room temperature bond energy was measured to be 268 mJ/m².

Self-propagation was observed for Example 2 comprising seven alternating layers of polymers to provide full bonding between glass sheets across approximately half of the surface area of the glass article. That is, while self-propagation occurred the observed self-propagation suggests that the roughness of the sample was completely overcome by the thicker polymer coating resulting from the additional two layers of polymer. The glass sheets of the article could be fully bonded using the lamination process set forth in Example 1 above. Once fully bonded, the room temperature bond energy was measured to be 399 mJ/m².

As expected, no bonding was observed for the control glass pair either by self-propagation or by lamination.

The results of the room temperature bonding experiments are shown below in Table 2.

TABLE 2
Bond Energy of Glass Articles as a Function
of Number of Polyelectrolyte Layers

| | | Bonding | |
|---|---|---|---|
| | Self- | After | BE at Room |
| | Propagation | Lamination | Temperature after |
| | Observed | Observed | Lamination(mJ/m²) |
| EAGLE XG ® | no | no | — |
| bare (control) | | | |
| EAGLE XG ® | no | yes | 268 |
| coated (5 layers) | | | |
| EAGLE XG ® | yes | yes | 399 |
| coated (7 layers) | (partial) | | |

As is evident from the foregoing, the untreated carrier+thin sheet glass pair (control) could not be bonded together either by self-propagation or by lamination. Self-propagation was not observed with the carrier+thin sheet pair comprising five polymeric layers. However, a fully bonded pair was obtained through lamination. Self-propagation of the glass article was observed in the glass pair comprising seven polymeric layers, to the extent that half of the area was bonded before lamination. This implies that the roughness on the sample containing seven polymeric layers was completely overcome by the thicker polymeric coating. With lamination, a fully-bonded substrate was obtained for both of the modification layers containing five and seven polymeric layers.

Bond Energies and Thermal Stability of Articles

Glass articles as prepared and laminated as above were heated to 250° C. (annealing temperature) in a Rapid Thermal Processing (RTP) chamber that ramped to the annealing temperature at a rate of 2° C. per second. Each bonded pair was then held in the furnace (maintained at the desired processing-test temperature of 250° C.) for 10 minutes. The furnace was then cooled to approximately 150° C. within 45 minutes, and the bonded pairs were pulled and cooled to room temperature. Once fully cooled, the bond energy of each of the articles was measured by inserting metal blades at the four corners and averaging the values. The results of the experiment are set forth below in Table 3.

TABLE 3
Bond Energy of Glass Articles as a Function of Number
of Polyelectrolyte Layers Following Thermal Annealing

| | BE after thermal | |
|---|---|---|
| | annealing to 250° C. (mJ/m²) | Debondable |
| EAGLE XG ® | 436 | yes |
| coated (5 layers) | | |
| EAGLE XG ® | 571 | yes |
| coated (7 layers) | | |

Based on the results, it is evident that thermal annealing of the bonded pair provides for much greater bond energy in both samples. This implies that the roughness on both samples was completely overcome when the thick, polymeric coatings were exposed to elevated temperatures. Advantageously, both articles were fully debondable (i.e. the carrier sheet was able to be fully removed from the thin sheet) by inserting a blade between the two sheets following annealing to 250° C.

Modification Layer Thickness Measurement

Alternating layers of cationic and anionic polymers were applied to silicon wafers and dried according to the procedure set forth above. The thickness of the deposited layers was then measured by elliposmetry.

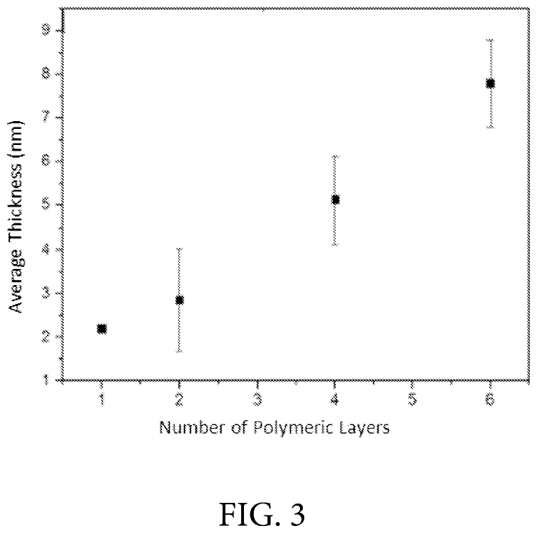

FIG. 3 shows the thickness of deposited coating (y-axis) as a function of the number of polymeric layers (x-axis) as measured by ellipsometry. The average measured thickness for 2 layers, 4 layers, and 6 layers was 2.9 nm, 5.1 nm, and 7.8 nm, respectively. The application of additional layers provides for the build-up of a thicker coating.

Taken together, improved bonding and increased bonding energies of articles having thicker modification layers appears to be consistent with an improvement in smoothing of the bonding surfaces prior to bonding.

It will be apparent to those skilled in the art that various modifications and variations can be made to the disclosed embodiments without departing from the spirit and scope of the disclosure. Thus, it is intended that the present disclosure cover any and all such modifications and variations as come within the scope of the appended claims and their equivalents.

For example, the modification layers disclosed herein may be used to bond a carrier to a thin sheet, to bond two carriers together, to bond two or more thin sheets together, or to bond a stack having various numbers of thin sheets and carriers together.

What is claimed is:

1. A method of manufacturing, comprising:
processing a thin sheet at a temperature in the range of 200° C. to 400° C., wherein the thin sheet is bonded to a second sheet with one or more anionic polymer and one or more cationic polymer, wherein average thickness of the thin sheet is 300 micrometers or less, wherein the thin sheet has a roughness, Rq, greater than 1 nanometer; and
removing the thin sheet from the second sheet without fracturing the thin sheet.

2. The method of claim 1, wherein the cationic polymer is water soluble.

3. The method of claim 1, wherein the cationic polymer comprises a polyalkyl backbone.

4. The method of claim 1, wherein the cationic polymer comprises a positively charged nitrogen.

5. The method claim 4, wherein the positively charged nitrogen is an ammonium cation.

6. The method of claim 1, wherein the anionic polymer is water soluble.

7. A modification layer for temporarily bonding a thin sheet to a carrier, the modification layer comprising
one or more cationic layers comprising one or more cationic polymers; and,
one or more anionic layers comprising one or more anionic polymers, the one or more anionic layers overlaying at least one of the one or more cationic layers.

8. The modification layer of claim 7, wherein the cationic polymer is water soluble.

9. The modification layer of claim 7, wherein the cationic polymer comprises a polyalkyl backbone.

10. The modification layer of claim 7, wherein the cationic polymer comprises a positively charged nitrogen.

11. The modification layer of claim 10, wherein the positively charged nitrogen is an ammonium cation.

12. The modification layer of claim 7, wherein the anionic polymer is water soluble.

13. The modification layer of claim 7, wherein the modification layer consists of alternating layers of first and second layers, the first layer being a monolayer of the cationic polymers and the second layer being a monolayer of the anionic polymers.

14. An article comprising:
a first sheet comprising a first sheet bonding surface;
a second sheet comprising a second sheet bonding surface; and,
a modification layer coupling the first sheet and second sheet, wherein the modification layer comprises:
(1) one or more cationic layers comprising one or more cationic polymers; and,
(2) one or more anionic layers comprising one or more anionic polymers.

15. The article of claim 14, wherein the cationic polymer is water soluble.

16. The article of claim 14, wherein the cationic polymer comprises a polyalkyl backbone.

17. The article of claim 14, wherein a repeating unit of the cationic polymer comprises one or more of a positively charged nitrogen, phosphorous, sulfur, boron or carbon.

18. The article of claim 17, wherein the repeating unit of the cationic polymer comprises a positively charged nitrogen.

19. The article of claim 17, wherein the repeating unit comprises 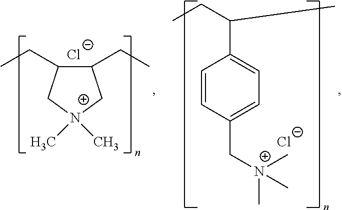
or combinations thereof.

20. The modification layer of claim 14, wherein the modification layer consists of alternating layers of first and second layers, the first layer being a monolayer of the cationic polymers and the second layer being a monolayer of the anionic polymers.
